(19) United States
(12) Patent Application Publication
(10) Pub. No.: US 2026/0210481 A1
(43) Pub. Date: Jul. 23, 2026

(54) ACTUATING APPARATUS

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 19/393,624

(22) Filed: Nov. 19, 2025

(30) Foreign Application Priority Data
Jan. 22, 2025 (TW) 114102765

(51) Int. Cl. F16M 11/04

(52) U.S. Cl. CPC F16M 11/041

(57) ABSTRACT

The present disclosure introduces an actuating apparatus. The actuating apparatus includes an actuating portion, a body portion, and a connection portion. The actuating portion is connected to the connection portion, and the connection portion is disposed on the body portion. A coupling portion is disposed in the actuating portion, a docking portion is disposed in the connection portion, and the coupling portion is actuated relative to or docked with the docking portion. Therefore, the body portion may be used to be mounted on an object, and the connection portion is driven to be connected to or disengaged from another object through the actuating portion, to implement rapid engagement and disengagement of at least two objects, thereby achieving an effect of repeated and rapid engagement and disengagement.

### CROSS-REFERENCE TO RELATED APPLICATION

This non-provisional application claims priority under 35 U.S.C. § 119(a) on Patent Application No(s). 114102765 filed in Taiwan, R.O.C. on Jan. 22, 2025, the entire contents of which are hereby incorporated by reference.

### BACKGROUND OF THE INVENTION

### 1. Field of the Invention

The present disclosure relates to an actuating apparatus, and in particular, to an actuating apparatus capable of repeatedly and rapidly engaging and disengaging at least two objects.

### 2. Description of the Related Art

Generally, when at least two objects are engaged, locking is usually performed by using a screw for engaging the objects.

In the foregoing conventional fixing manner, although the at least two objects may be fixedly engaged in a manner of being not easy to be disengaged, in addition to causing a case of being not easy to be assembled, the at least two objects may be not easily disassembled due to the fixedly engaging manner of the screw.

### BRIEF SUMMARY OF THE INVENTION

In an actuating apparatus of the present disclosure, a body portion may be used to be mounted on an object, and a connection portion is driven to be connected to or disengaged from another object through an actuating portion, to implement rapid engagement and disengagement of at least two objects, thereby achieving an effect of repeated and rapid engagement and disengagement.

To achieve the foregoing objective and other objectives, the present disclosure provides an actuating apparatus, including an actuating portion, a body portion, and a connection portion. The actuating portion is configured to be connected to the connection portion, and the connection portion is disposed on the body portion.

The present disclosure provides another actuating apparatus, including an actuating portion, a body portion, and a connection portion. The actuating portion is configured to be connected to the connection portion, and the connection portion is disposed on the body portion; or the actuating portion is connected to the connection portion through an assembly portion, and the connection portion is disposed on the body portion. A coupling portion is disposed in the actuating portion, a docking portion is disposed in the connection portion, and the coupling portion is assembled with or actuated relative to the docking portion.

The present disclosure provides another actuating method for an actuating apparatus, which provides an actuating apparatus. The actuating apparatus includes an actuating portion, a body portion, and a connection portion. The actuating portion is configured to be connected to the connection portion, and actively combine the connection portion with the body portion, or the actuating portion is connected to the connection portion through an assembly portion, and actively combines the connection portion with the body portion. A coupling portion is disposed in the actuating portion, a docking portion is disposed in the connection portion, the coupling portion is actuated relative to or docked with the docking portion, or the coupling portion is actuated or docked in the docking portion; and the body portion is mounted on an object, and the connection portion is driven to be connected to or disengaged from another object through the actuating portion.

Optionally, the docking portion is a slot portion or a hole portion, or the coupling portion is a two-side cross-sectional structure or a cylindrical body, or the coupling portion is a structure or a cylindrical body that is thinner than the actuating portion.

Optionally, a passage portion is disposed in the body portion, and the passage portion is configured for the connection portion to move or pass through, where the actuating portion is larger than the passage portion, to serve as a limit.

Optionally, a passage portion is disposed in the body portion, and the passage portion is configured for the connection portion to move or pass through, where the coupling portion is larger than the passage portion, and is configured to abut against, limit, lift, or move the connection portion.

Optionally, a mounting portion is disposed in the body portion, and the mounting portion is configured to be mounted on an object, or the body portion and the object are integrally formed, or the mounting portion is configured to be riveted, expanded, welded, locked, or fastened to the object.

Optionally, an elastic component is further included. The elastic component abuts against the body portion and the connection portion, and the elastic component is configured to apply an elastic force, or is configured to pull the actuating portion, or is configured to elastically pull the actuating portion, or is configured to apply a pulling force or an elastic force at positions of different heights or a same height when the actuating portion is rotated or moved, or is configured to apply a pulling force or an elastic force at positions of different heights or a same height through elasticity when the actuating portion is rotated or moved.

Optionally, a limiting portion is disposed in the connection portion, and the limiting portion is configured to limit the body portion, or the limiting portion limits the body portion between the actuating portion and the connection portion.

Optionally, a fastening portion is disposed in the connection portion, and the fastening portion is configured to be connected to another object, or the fastening portion is a cylindrical body, a threaded body, an elastic fastening body, a convex fastening body, or a concave fastening body.

Optionally, the coupling portion is a slot portion of a cross-sectional body configured to be disposed in the connection portion, or the coupling portion is a through hole or a through slot configured to be disposed in the connection portion, or configured to be assembled with the connection portion; or the coupling portion is a slot portion of a cross-sectional body configured to be disposed in the docking portion, or the coupling portion is a through hole or a through slot configured to be disposed in the docking portion, or configured to be assembled with the docking portion.

Optionally, the coupling portion fits the body portion, configured to move the connection portion to an upper position or a lower position.

Optionally, an end of the coupling portion abuts against the body portion, or a side surface of the coupling portion abuts against the body portion, or the coupling portion is a flat surface or a curved surface.

Optionally, an intermediate body is disposed between the actuating portion and the body portion, and the intermediate body contacts, abuts against, or interferes with the actuating portion or the body portion.

Optionally, an intermediate body is disposed between the actuating portion and the body portion, the intermediate body has two penetrating portions and an abutment portion, and two docking portions are disposed in the connection portion.

Optionally, the body portion has two penetrating portions and an abutment portion, and two docking portions are disposed in the connection portion.

Optionally, an intermediate body is disposed between the actuating portion and the body portion, and the intermediate body has at least one penetrating portion or an abutment portion, or the penetrating portion is configured for the connection portion or the docking portion to pass through, or the abutment portion is configured to contact or abut against the actuating portion or the coupling portion, or there are two penetrating portions, configured for the connection portion or the docking portion to pass through, or the abutment portion is located between the two penetrating portions, configured to contact or abut against the actuating portion or the coupling portion, or the abutment portion is located between the two penetrating portions, configured to contact or abut against the actuating portion or the coupling portion, to cause the actuating portion or the coupling portion to remain above the body portion when the actuating portion or the coupling portion is abutted against or rotated.

Optionally, the docking portion is assembled with the coupling portion after passing through the body portion and the penetrating portion of the intermediate body.

Optionally, at least one penetrating portion and an abutment portion are disposed in the body portion, and the docking portion is assembled with the coupling portion through the penetrating portion; or two penetrating portions are disposed in the body portion, and two docking portions are disposed in the connection portion, an abutment portion is disposed between the penetrating portions, and the docking portions pass through the penetrating portions to be assembled with the coupling portion, or to cause the coupling portion to abut against the abutment portion, or the abutment portion is located between the two penetrating portions, to contact or abut against the actuating portion or the coupling portion, to cause the actuating portion or the coupling portion to remain above the body portion when the actuating portion or the coupling portion is abutted against or rotated.

Optionally, an intermediate body is disposed between the actuating portion and the body portion, the intermediate body has a limiting portion, and the limiting portion is configured to limit a rotation angle, a motion path, or a motion range of the actuating portion; or the body portion has a limiting portion, or the limiting portion is configured to limit a rotation angle, a motion path, or a motion range of the actuating portion.

Optionally, a clearance portion is disposed in the actuating portion, and the clearance portion and the limiting portion provide clearance.

Optionally, the limiting portion limits the actuating portion at 90 degrees; or the limiting portion limits the actuating portion at approximately 90 degrees, or the limiting portion limits the actuating portion between 30 degrees and 150 degrees.

Optionally, a limiting portion is disposed in the connection portion or the docking portion, and the limiting portion limits a rotation angle, a motion path, or a motion range of the actuating portion.

Optionally, the actuating apparatus is a fastening body, a handle, a lifting body, a heat dissipation body, a heat-generating body, a power-on body, a slide rail, a threaded body, a cylindrical body, a welded body, a riveted body, an expanded body, a locked body, a pipe body, a concave body, or a convex body.

Optionally, the actuating apparatus is configured to be disposed on a chassis, a rack, a mainboard, a chip, a heat dissipater, a heat dissipation body, a water cooling pipe, a slide rail, a fan, a server, a computer, a storage, an AI device, a metal body, or a plastic body.

The present disclosure provides another actuating method for an actuating apparatus, which provides an actuating apparatus. The actuating apparatus includes an actuating portion, a body portion, and a connection portion. The actuating portion is configured to be connected to the connection portion, and the connection portion is actively combined with the body portion; or the actuating portion is configured to be connected to the connection portion through an assembly portion, and the connection portion is actively combined with the body portion. A coupling portion is disposed in the actuating portion, a docking portion is disposed in the connection portion, or the coupling portion is actuated relative to or docked with the docking portion, or the coupling portion is activated or docked in the docking portion; or an intermediate body is disposed between the actuating portion and the body portion, or the intermediate body contacts, abuts against, or interferes with the actuating portion or the body portion; or an intermediate body is disposed between the actuating portion and the body portion, and the intermediate body has at least one penetrating portion or an abutment portion, or the penetrating portion is configured for the connection portion or the docking portion to pass through, or the abutment portion is configured to contact or abut against the actuating portion or the coupling portion, or two penetrating portions are provided, configured for the connection portion or the docking portion to pass through, or the abutment portion is located between the two penetrating portions, configured to contact or abut against the actuating portion or the coupling portion, or the abutment portion is located between the two penetrating portions, configured to contact or abut against the actuating portion or the coupling portion, to cause the actuating portion or the coupling portion to remain above the body portion when the actuating portion or the coupling portion is abutted against or rotated; or the docking portion is assembled with the coupling portion after passing through the body portion and the penetrating portion of the intermediate body; or at least one penetrating portion and an abutment portion are disposed in the body portion, and the docking portion is assembled with the coupling portion through the penetrating portion; or two penetrating portions are disposed in the body portion, and two docking portions are disposed in the connection portion, an abutment portion is disposed between the penetrating portions, and the docking portions pass through the penetrating portions to be assembled with the coupling portion, or to cause the coupling portion to abut against the abutment portion, or the abutment portion is located between the two penetrating portions, to contact or abut against the actuating portion or the coupling portion, to cause the actuating portion or the coupling portion to remain above the body portion when the actuating portion or the coupling portion is abutted against or rotated.

### BRIEF DESCRIPTION OF THE DRAWINGS

To describe technical solutions in embodiments of the present utility model or the prior art more clearly, the following briefly describes the accompanying drawings required for describing the embodiments. It is clear that the accompanying drawings in the following descriptions only show some embodiments of the present utility model, and a person of ordinary skill in the art may still derive other drawings from these accompanying drawings without creative efforts.

FIG. 1 is a schematic exploded view according to a first embodiment of the present disclosure.

FIG. 2 is a schematic diagram 1 of a usage status according to a first embodiment of the present disclosure.

FIG. 3 is a schematic diagram 2 of a usage status according to a first embodiment of the present disclosure.

FIG. 4 is a schematic diagram of a connection portion according to a second embodiment of the present disclosure.

FIG. 5 is a schematic diagram of a usage status according to a second embodiment of the present disclosure.

FIG. 6 is a schematic diagram of an actuating portion according to a third embodiment of the present disclosure.

FIG. 7 is a schematic diagram of a usage status according to a third embodiment of the present disclosure.

FIG. 8 is a schematic exploded view of a connection portion and an intermediate body according to a fourth embodiment of the present disclosure.

FIG. 9 is a schematic diagram of a usage status according to a fourth embodiment of the present disclosure.

FIG. 10 is a schematic exploded view of a connection portion and an intermediate body according to a fifth embodiment of the present disclosure.

FIG. 11 is a schematic diagram of a usage status according to a fifth embodiment of the present disclosure.

FIG. 12 is a schematic exploded view of a body portion and a connection portion according to a sixth embodiment of the present disclosure.

FIG. 13 is a schematic diagram of a usage status according to a sixth embodiment of the present disclosure.

FIG. 14 is a schematic diagram of a usage status according to a seventh embodiment of the present disclosure.

FIG. 15 is a schematic diagram of a usage status according to an eighth embodiment of the present disclosure.

FIG. 16 is a schematic diagram of a usage status according to a ninth embodiment of the present disclosure.

FIG. 17 is a schematic diagram of a usage status according to a ninth embodiment of the present disclosure.

### DETAILED DESCRIPTION OF THE INVENTION

The following further describes an actuating apparatus in embodiments of the present disclosure with reference to the accompanying drawings.

The foregoing and other technical contents, features, and effects of the utility model are to be clearly presented in the following detailed descriptions of preferred embodiments with reference to the accompanying drawings. It should be noted that, directional terms such as “upper”, “lower”, “left”, “right”, “front”, or “rear” mentioned in the following embodiments are only directions with reference to the accompanying drawings. Therefore, the used directional terms are used for description, and are not intended to constitute a limitation on the present utility model. In addition, in the following embodiments, the same or the similar components use the same or the similar reference numbers.

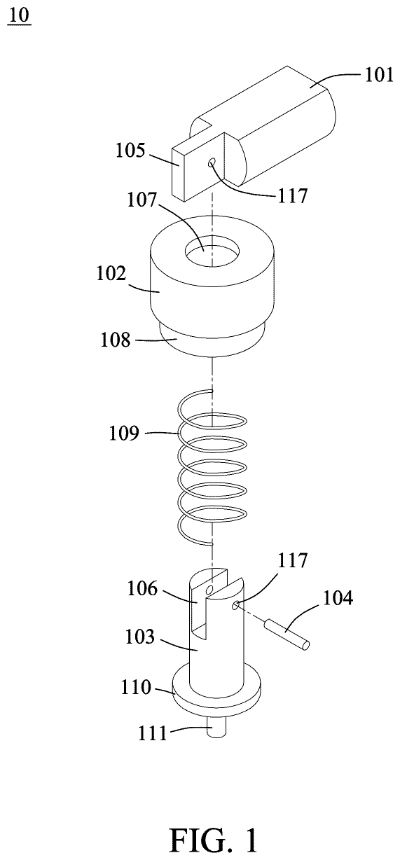

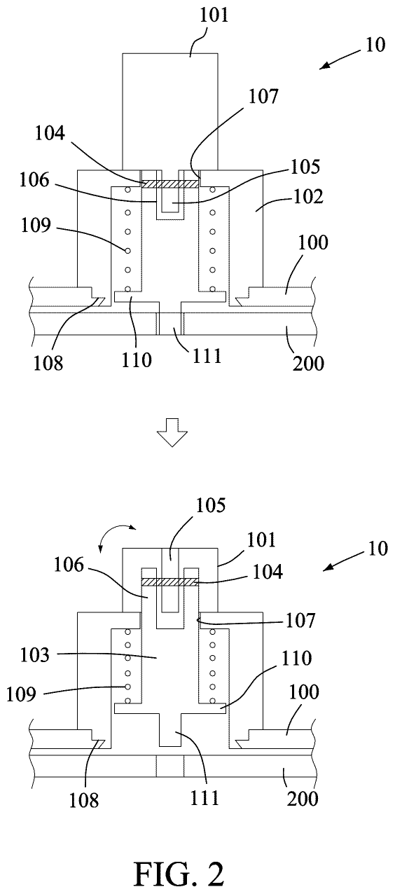

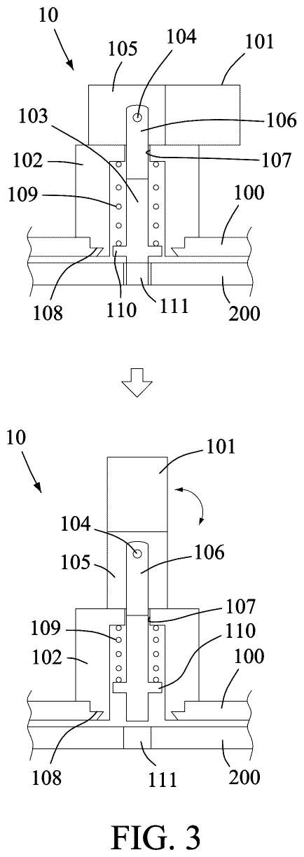

Referring to FIG. 1 to FIG. 3, as shown in the figures, the present disclosure provides an actuating apparatus. The actuating apparatus 10 includes an actuating portion 101, a body portion 102, and a connection portion 103. The actuating portion 101 is configured to be connected to the connection portion 103, and the connection portion 103 is disposed on the body portion 102 (for example, an active combination). In an embodiment of the present disclosure, the actuating portion 101 is connected to the connection portion 103 through an assembly portion 104 (for example, the assembly portion 104 is a pin component, and the actuating portion 101 and the connection portion 103 are each provided with a through hole 117 for the assembly portion 104 to pass through), and the connection portion 103 is disposed on the body portion 102 (for example, an active combination). A coupling portion 105 is disposed in the actuating portion 101, a docking portion 106 is disposed in the connection portion 103, and the coupling portion 105 is assembled with, actuated relative to, or docked with the docking portion 106 (for example, the coupling portion 105 is actuated or docked in the docking portion 106).

In an actuating method of the present disclosure, the foregoing actuating apparatus 10 is mounted on an object 100 by using the body portion 102. For example, the actuating apparatus 10 may be disposed on a chassis, a rack, a mainboard, a chip, a heat dissipater, a heat dissipation body, a water cooling pipe, a slide rail, a fan, a server, a computer, a storage, an AI device, a metal body, or a plastic body, and the connection portion 103 is driven to be connected to or disengaged from another object 200 through rotation of the actuating portion 101, to implement rapid engagement and disengagement of at least two objects (the object 100 and the another object 200), thereby achieving an effect of repeated and rapid engagement and disengagement.

In an embodiment of the present disclosure, the docking portion 106 may be a slot portion or a hole portion, and the coupling portion 105 may be a two-side cross-sectional structure or a cylindrical body (or the coupling portion 105 is a structure or a cylindrical body that is thinner than the actuating portion 101). In this embodiment, the coupling portion 105 is a cross-sectional body, and the docking portion 106 of the connection portion 103 is a slot portion disposed corresponding to the cross-sectional body, or the coupling portion 105 may be a cross-sectional body having a through hole or a through slot, to be disposed in the connection portion 103, and cause an end of the coupling portion 105 to abut against the body portion 102 and cause a side surface of the coupling portion 105 to abut against the body portion 102, or the coupling portion 105 may be a flat surface or a curved surface. In this way, through cooperation of the assembly portion 104, the coupling portion 105, and the docking portion 106, the actuating portion 101 and the connection portion 103 may be actively combined with the body portion 102, so that the connection portion 103 is driven to be connected to or disengaged from the another object 200 through rotation of the actuating portion 101.

In an embodiment of the present disclosure, a passage portion 107 is disposed in the body portion 102, the passage portion 107 is configured for the connection portion 103 to move or pass through, and the actuating portion 101 may be larger than the passage portion 107, to serve as a limit. In this way, the passage portion 107 may be used as a moving space, so that the connection portion 103 is driven to be connected to or disengaged from the another object 200 through rotation of the actuating portion 101.

In an embodiment of the present disclosure, the coupling portion 105 of the actuating portion 101 is larger than the passage portion 107, and is configured to abut against, limit, lift, or move the connection portion 103. In this way, the passage portion 107 may be used as a moving space, so that the connection portion 103 is driven to be connected to or disengaged from the another object 200 through rotation of the actuating portion 101.

In an embodiment of the present disclosure, a mounting portion 108 is disposed in the body portion 102, and the mounting portion 108 is configured to be mounted on the object 100 in a manner such as riveting, expanding, welding, locking, or fastening, or the body portion 102 and the object 100 are integrally formed. In this way, assembly stability between the body portion 102 and the object 100 is desirable, and the body portion 102 is stably disposed on the object 100, to meet at least a requirement that the actuating portion 101 and the connection portion 103 perform an actual force-applying operation.

In an embodiment of the present disclosure, an elastic component 109 is further included. The elastic component 109 abuts against the body portion 102 and the connection portion 103, and the elastic component 109 is configured to apply an elastic force, to pull the actuating portion 101 or elastically pull the actuating portion 101, or apply a pulling force or an elastic force at positions of different heights or a same height when the actuating portion 101 is rotated or moved, or apply a pulling force or an elastic force at positions of different heights or a same height through elasticity when the actuating portion 101 is rotated or moved. In this way, the elastic component 109 may be used to maintain stability when the connection portion 103 is driven to operate through rotation of the actuating portion 101.

In an embodiment of the present disclosure, a limiting portion 110 is disposed in the connection portion 103, and the limiting portion 110 is configured to limit the body portion 102. For example, in this embodiment, the limiting portion 110 may limit the body portion 102, so that the body portion 102 is located between the actuating portion 101 and the connection portion 103, and two ends of the elastic component 109 respectively abut against the body portion 102 and the limiting portion 110. In this way, the limiting portion 110 may be used alone, or the limiting portion 110 may be used in cooperation with the elastic component 109 to maintain stability when the connection portion 103 is driven to operate through rotation of the actuating portion 101.

In an embodiment of the present disclosure, a fastening portion 111 is disposed in the connection portion 103, and the fastening portion 111 is configured to be connected to the another object 200. In this way, the connection portion 103 may be driven through rotation of the actuating portion 101, so that the connection portion 103 is connected to or disengaged from the another object 200 through the fastening portion 111.

In an embodiment of the present disclosure, the fastening portion 111 may be a cylindrical body, a threaded body, an elastic fastening body, a convex fastening body, or a concave fastening body. In this way, the fastening portion 111 of the present disclosure can further meet a fastening requirement.

In an embodiment of the present disclosure, the coupling portion 105 fits the body portion 102, configured to move the connection portion 103 to an upper position or a lower position. In this way, when the actuating portion 101 moves the connection portion 103 to the upper position, the fastening portion 111 of the connection portion 103 may be driven to be disengaged from the another object 200; and when the actuating portion 101 moves the connection portion 103 to the lower position, the fastening portion 111 of the connection portion 103 may be driven to be connected to the another object 200.

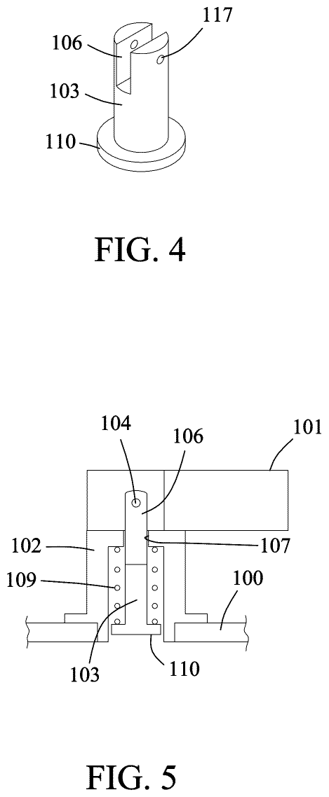

Referring to FIG. 4 and FIG. 5, as shown in the figures, in an embodiment of the present disclosure, based on a requirement, only the limiting portion 110 may be disposed in the connection portion 103, and the fastening portion 111 may not be disposed, so that the connection portion 103 is connected to the another object 200 in another manner or connected to a fastening portion on the another object 200. In this way, the present disclosure can better meet an operational requirement of actual application.

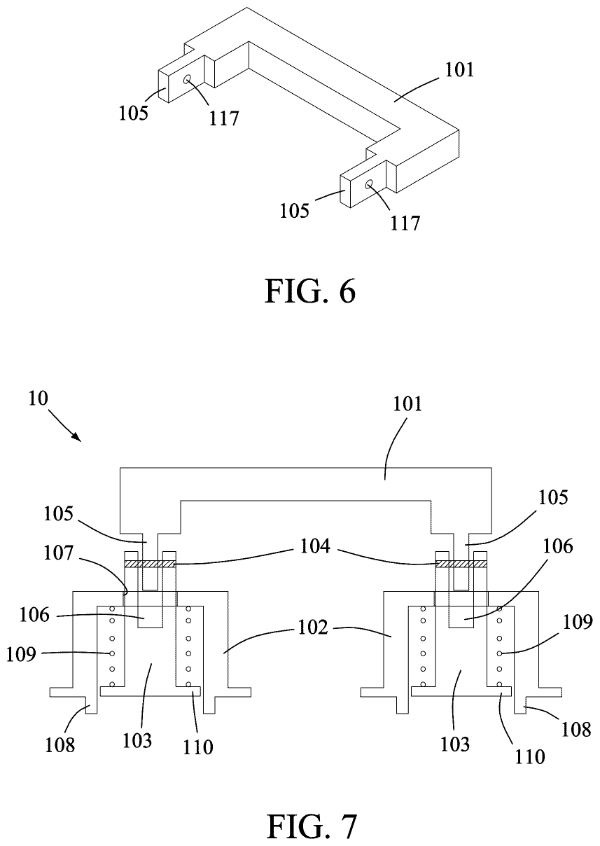

Referring to FIG. 6 and FIG. 7, as shown in the figures, in an embodiment of the present disclosure, two coupling portions 105 are disposed in the actuating portion 101 of the actuating apparatus 10, so that the actuating portion 101 is formed in a form of a handle. In addition, there are also two body portions 102 and two connection portions 103 respectively, so that the body portions 102 and the connection portions 103 are respectively assembled with the coupling portions 105 correspondingly. In this way, the body portions 102 may be mounted on the object 100, and the connection portions 103 are driven to be connected to or disengaged from the another object 200 through rotation of the actuating portion 101, to implement rapid engagement and disengagement of at least two objects (the object 100 and the another object 200), thereby achieving an effect of repeated and rapid engagement and disengagement.

In an embodiment of the present disclosure, a difference from the foregoing embodiments lies in that, in addition to the foregoing handle form, the actuating apparatus 10 may be a fastening body, a lifting body, a heat dissipation body, a heat-generating body, a power-on body, a slide rail, a threaded body, a cylindrical body, a welded body, a riveted body, an expanded body, a locked body, a pipe body, a concave body, or a convex body. In this way, the present disclosure can better meet an operational requirement of actual application.

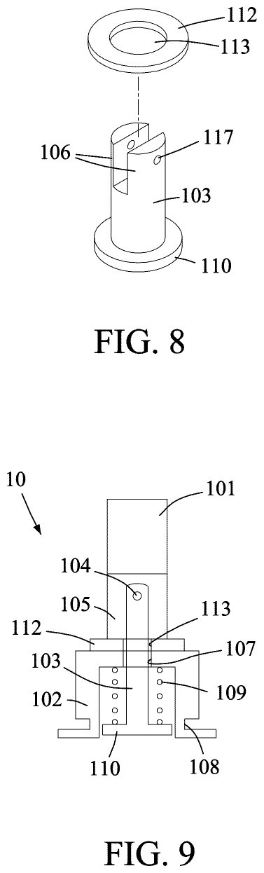

Referring to FIG. 8 and FIG. 9, as shown in the figures, in an embodiment of the present disclosure, an intermediate body 112 is disposed between the actuating portion 101 and the body portion 102 of the actuating apparatus 10. The intermediate body 112 has at least one penetrating portion 113, and the docking portion 106 is assembled with the coupling portion 105 through the assembly portion 104 after passing through the body portion 102 and the penetrating portion 113 of the intermediate body 112. In this way, when the actuating portion 101 is operated, the intermediate body 112 and the actuating portion 101 may be caused to contact, abut against, or interfere with the body portion 102.

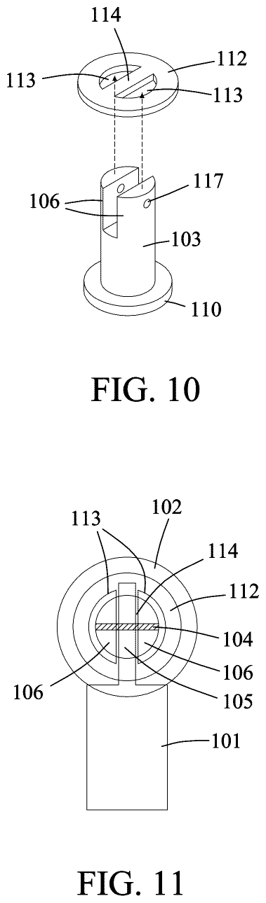

Referring to FIG. 10 and FIG. 11, as shown in the figures, in an embodiment of the present disclosure, the intermediate body 112 has at least one penetrating portion 113 and an abutment portion 114. The penetrating portion 113 is configured for the docking portion 106 of the connection portion 103 to pass through, and the abutment portion 114 is configured to contact or abut against the coupling portion 105 of the actuating portion 101, so that the docking portion 106 is assembled with the coupling portion 105 through the assembly portion 104 after passing through the body portion 102 and the penetrating portion 113 of the intermediate body 112. In this way, when the actuating portion 101 is operated, the intermediate body 112 and the actuating portion 101 may be caused to contact, abut against, or interfere with the body portion 102, so that when the actuating portion 101 moves the connection portion 103 to the upper position, the fastening portion 111 of the connection portion 103 may be driven to be disengaged from the another object 200; and when the actuating portion 101 abuts against the abutment portion 114, the connection portion 103 is moved to the upper position or the lower position.

In an embodiment of the present disclosure, there are two penetrating portions 113, configured for the connection portion 103 or the docking portion 106 to pass through. The abutment portion 114 is located between the two penetrating portions 113, configured to contact or abut against the actuating portion 101 or the coupling portion 105. In this way, the present disclosure can better meet an operational requirement of actual application.

In an embodiment of the present disclosure, the abutment portion 114 is located between the two penetrating portions 113, to contact or abut against the actuating portion 101 or the coupling portion 105, to cause the actuating portion 101 or the coupling portion 105 to maintain above the body portion 102 when the actuating portion 101 or the coupling portion 105 is abutted against or rotated. In this way, the present disclosure can better meet an operational requirement of actual application.

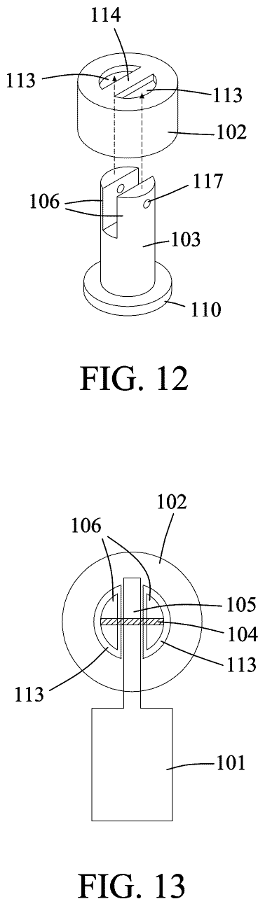

Referring to FIG. 12 and FIG. 13, as shown in the figures, in an embodiment of the present disclosure, at least one penetrating portion 113 and an abutment portion 114 are disposed in the body portion 102, and the docking portion 106 is assembled with the coupling portion 105 through the penetrating portion. In the present disclosure, two penetrating portions 113 are disposed in the body portion 102, two docking portions 106 are disposed in the connection portion 103, and the abutment portion 114 is disposed between the penetrating portions 113, so that each of the docking portions 106 passes through each of the penetrating portions 113 to be assembled with the coupling portion 105, to cause the coupling portion 105 to abut against the abutment portion 114. In this way, the actuating portion 101 may abut against the abutment portion 114, to move the connection portion 103 to the upper position or the lower position.

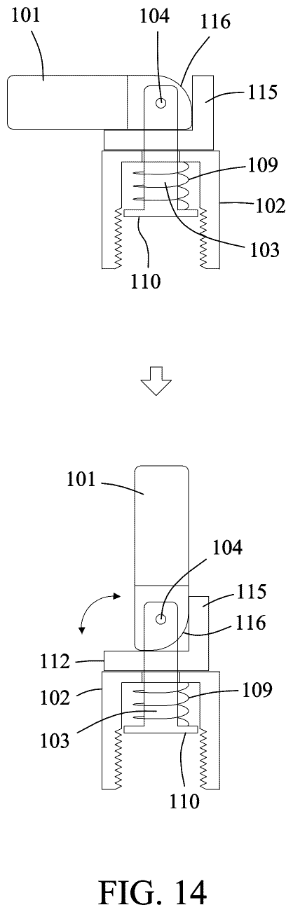

Referring to FIG. 14, as shown in the figure, in an embodiment of the present disclosure, the intermediate body 112 may be disposed between the actuating portion 101 and the body portion 102, the intermediate body 112 has a limiting portion 115, and the limiting portion 115 is configured to limit a rotation angle, a motion path, or a motion range of the actuating portion 101.

In an embodiment of the present disclosure, a clearance portion 116 is disposed in the actuating portion 101, and the clearance portion 116 and the limiting portion 115 provide clearance. In this way, the rotation angle, the motion path, or the motion range of the actuating portion 101 may be limited by the limiting portion 115 after the actuating portion 101 is rotated to a predetermined angle through the clearance portion 116, to avoid oversteer.

In an embodiment of the present disclosure, the limiting portion 115 may limit an actuating angle of the actuating portion 101 to be 90 degrees (or the limiting portion 115 limits the actuating portion 101 to be approximately 90 degrees), or the limiting portion 115 may limit an actuating angle of the actuating portion 101 to be between 30 degrees and 150 degrees.

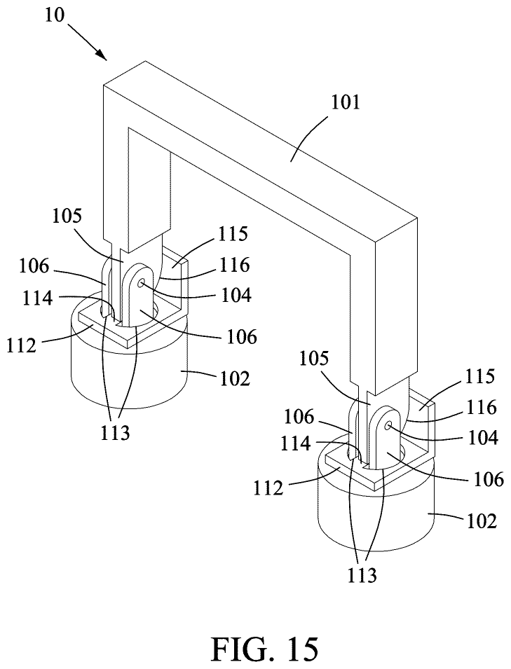

Referring to FIG. 15, as shown in the figure, in an embodiment of the present disclosure, two coupling portions 105 are disposed in the actuating portion 101 of the actuating apparatus 10. In this case, the actuating portion 101 is formed in a form of a handle, there are also two body portions 102, connection portions 103, and intermediate bodies 112 respectively, the body portions 102 and the connection portions 103 are respectively assembled with the coupling portions 105 correspondingly, and the intermediate body 112 is located between the body portion 102 and the coupling portion 105. In this way, the body portions 102 may be mounted on the object 100, and the actuating portion 101 is rotated to abut against the abutment portion 114, to cause the actuating portion 101 to move the connection portion 103 to the upper position or the lower position. In this case, the connection portions 103 is driven to be connected to or disengaged from the another object 200, to implement rapid engagement and disengagement of at least two objects (the object 100 and the another object 200), thereby achieving an effect of repeated and rapid engagement and disengagement.

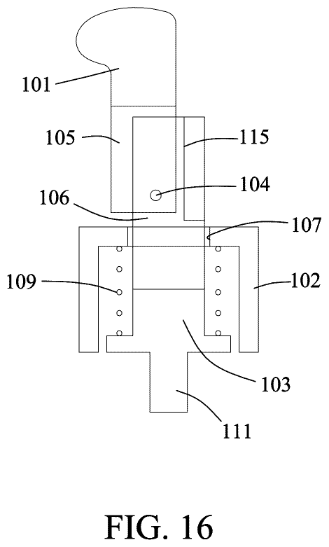

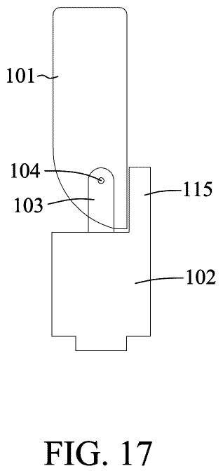

Referring to FIG. 16, as shown in the figure, in an embodiment of the present disclosure, a limiting portion 115 is disposed in the connection portion 103 or the docking portion 106, and the limiting portion 115 limits a rotation angle, a motion path, or a motion range of the actuating portion 101. In this way, the rotation angle, the motion path, or the motion range of the actuating portion 101 may be limited by the limiting portion 115 after the actuating portion 101 is rotated to a predetermined angle, to avoid oversteer.

Referring to FIG. 16, as shown in the figure, in an embodiment of the present disclosure, the body portion 102 has a limiting portion 115, and the limiting portion 115 is configured to limit a rotation angle, a motion path, or a motion range of the actuating portion 101. In this way, the rotation angle, the motion path, or the motion range of the actuating portion 101 may be limited by the limiting portion 115 after the actuating portion 101 is rotated to a predetermined angle, to avoid oversteer.

In conclusion, in the actuating apparatus of the present disclosure, the body portion may be used to be mounted on the object, and the connection portion is driven to be connected to or disengaged from the another object through the actuating portion, to implement the rapid engagement and disengagement of the at least two objects, thereby achieving the effect of repeated and rapid engagement and disengagement.

The foregoing descriptions are merely the embodiments of the present disclosure, and are not intended to limit the patent scope of the present disclosure.

What is claimed is:

1. An actuating apparatus, comprising:
an actuating portion;
a body portion; and
a connection portion;
wherein the actuating portion is configured to be connected to the connection portion, and the connection portion is disposed on the body portion.

2. The actuating apparatus according to claim 1, wherein the actuating portion is configured to be connected to the connection portion through an assembly portion, and the connection portion is disposed on the body portion; or a coupling portion is disposed in the actuating portion, or a docking portion is disposed in the connection portion, or the coupling portion is assembled with or actuated relative to the docking portion.

3. The actuating apparatus according to claim 2, wherein the docking portion is a slot portion or a hole portion, or the coupling portion is a two-side cross-sectional structure or a cylindrical body, or the coupling portion is a structure or a cylindrical body that is thinner than the actuating portion.

4. The actuating apparatus according to claim 1, wherein a passage portion is disposed in the body portion, the passage portion is configured for the connection portion to move or pass through, and the actuating portion is larger than the passage portion, to serve as a limit; or a passage portion is disposed in the body portion, the passage portion is configured for the connection portion to move or pass through, or the coupling portion is larger than the passage portion, and is configured to abut against, limit, lift, or move the connection portion.

5. The actuating apparatus according to claim 1, wherein a mounting portion is disposed in the body portion, and the mounting portion is configured to be mounted on an object, or the body portion and the object are integrally formed, or the mounting portion is configured to be riveted, expanded, welded, locked, or fastened to the object.

6. The actuating apparatus according to claim 1, further comprising an elastic component, wherein the elastic component abuts against the body portion and the connection portion, and the elastic component is configured to apply an elastic force, or is configured to pull the actuating portion, or is configured to elastically pull the actuating portion, or is configured to apply a pulling force or an elastic force at positions of different heights or a same height when the actuating portion is rotated or moved, or is configured to apply a pulling force or an elastic force at positions of different heights or a same height through elasticity when the actuating portion is rotated or moved.

7. The actuating apparatus according to claim 1, wherein a limiting portion is disposed in the connection portion, and the limiting portion is configured to limit the body portion, or the limiting portion limits the body portion between the actuating portion and the connection portion; or a fastening portion is disposed in the connection portion, or the fastening portion is configured to be connected to another object, or the fastening portion is a cylindrical body, a threaded body, an elastic fastening body, a convex fastening body, or a concave fastening body.

8. The actuating apparatus according to claim 2, wherein the coupling portion is a slot portion of a cross-sectional body configured to be disposed in the connection portion, or the coupling portion is a through hole or a through slot configured to be disposed in the connection portion, or configured to be assembled with the connection portion; or the coupling portion is a slot portion of a cross-sectional body configured to be disposed in the docking portion, or the coupling portion is a through hole or a through slot configured to be disposed in the docking portion, or configured to be assembled with the docking portion.

9. The actuating apparatus according to claim 2, wherein the coupling portion fits the body portion, configured to move the connection portion to an upper position or a lower position; or an end of the coupling portion abuts against the body portion, or a side surface of the coupling portion abuts against the body portion, or the coupling portion is a flat surface or a curved surface.

10. The actuating apparatus according to claim 1, wherein an intermediate body is disposed between the actuating portion and the body portion, or the intermediate body contacts, abuts against, or interferes with the actuating portion or the body portion; or an intermediate body is disposed between the actuating portion and the body portion, the intermediate body has two penetrating portions and an abutment portion, and two docking portions are disposed in the connection portion.

11. The actuating apparatus according to claim 1, wherein the body portion has two penetrating portions and an abutment portion, and two docking portions are disposed in the connection portion.

12. The actuating apparatus according to claim 2, wherein an intermediate body is disposed between the actuating portion and the body portion, and the intermediate body has at least one penetrating portion or an abutment portion, or the penetrating portion is configured for the connection portion or the docking portion to pass through, or the abutment portion is configured to contact or abut against the actuating portion or the coupling portion, or two penetrating portions are provided, configured for the connection portion or the docking portion to pass through, or the abutment portion is located between the two penetrating portions, configured to contact or abut against the actuating portion or the coupling portion, or the abutment portion is located between the two penetrating portions, configured to contact or abut against the actuating portion or the coupling portion, to cause the actuating portion or the coupling portion to remain above the body portion when the actuating portion or the coupling portion is abutted against or rotated; or the docking portion is assembled with the coupling portion after passing through the body portion and the penetrating portion of the intermediate body.

13. The actuating apparatus according to claim 2, wherein at least one penetrating portion and an abutment portion are disposed in the body portion, and the docking portion is assembled with the coupling portion through the penetrating portion; or two penetrating portions are disposed in the body portion, and two docking portions are disposed in the connection portion, an abutment portion is disposed between the penetrating portions, and the docking portions pass through the penetrating portions to be assembled with the coupling portion, or to cause the coupling portion to abut against the abutment portion, or the abutment portion is located between the two penetrating portions, to contact or abut against the actuating portion or the coupling portion, to cause the actuating portion or the coupling portion to remain above the body portion when the actuating portion or the coupling portion is abutted against or rotated.

14. The actuating apparatus according to claim 1, wherein an intermediate body is disposed between the actuating portion and the body portion, the intermediate body has a limiting portion, or the limiting portion is configured to limit a rotation angle, a motion path, or a motion range of the actuating portion; or the body portion has a limiting portion, or the limiting portion is configured to limit a rotation angle, a motion path, or a motion range of the actuating portion; or a clearance portion is disposed in the actuating portion, and the clearance portion and the limiting portion provide clearance; or the limiting portion limits the actuating portion at 90 degrees; or the limiting portion limits the actuating portion at approximately 90 degrees, or the limiting portion limits the actuating portion between 30 degrees and 150 degrees.

15. The actuating apparatus according to claim 2, wherein a limiting portion is disposed in the connection portion or the docking portion, or the limiting portion is configured to limit a rotation angle, a motion path, or a motion range of the actuating portion.

16. The actuating apparatus according to claim 1, wherein the actuating apparatus is a fastening body, a handle, a lifting body, a heat dissipation body, a heat-generating body, a power-on body, a slide rail, a threaded body, a cylindrical body, a welded body, a riveted body, an expanded body, a locked body, a pipe body, a concave body, or a convex body; or the actuating apparatus is configured to be disposed on a chassis, a rack, a mainboard, a chip, a heat dissipater, a heat dissipation body, a water cooling pipe, a slide rail, a fan, a server, a computer, a storage, an AI device, a metal body, or a plastic body.
